(19) United States
(12) Patent Application Publication
(10) Pub. No.: US 2005/0087285 A1
(43) Pub. Date: Apr. 28, 2005

(54) Method and means for facilitating the repair of chipped glass

(76) Inventor: Troy A. Heien, Laramie, WY (US)

Correspondence Address: ROLAND H. SHUBERT, POST OFFICE BOX 2339, RESTON, VA, 20195-0339, US

(21) Appl. No.: 10/971,848

(22) Filed: Oct. 22, 2004

Related U.S. Application Data
(60) Provisional application No. 60/514,750, filed on Oct. 27, 2003.

(51) Int. Cl. B32B 35/00

(52) U.S. Cl. 156/94; 156/573

(57) ABSTRACT

A chip preserver system for keeping a newly created chip in a vehicle windshield or other glass member clean and dry until a permanent repair can be made. The system includes a transparent plastic shield having adhesive on one side that strongly adheres to the glass and holds the shield in place, covering the damaged area and a perimeter around that area and withstanding the impact of wind and rain and the abrasion of windshield wipers, until the shield is removed at the time of repair. A supply of shields, each carried on a backing sheet, is provided in a dispenser that is arranged for storage at a location that allows for immediate availability upon need. Indicia that may include the location of a repair service or the identity of an insurance agent or company may be printed on the shield, thus making the system a useful and attractive advertising premium.

### REFERENCE TO RELATED APPLICATION

This application claims the benefit of U.S. Provisional Patent Application No. 60/514,750 that was filed on Oct. 27, 2003.

### BACKGROUND OF THE INVENTION

1. Technical Field

This invention relates to a method for facilitating the repair of chips formed in glass, such as those formed in automobile windshields by gravel or other road debris striking the glass, and to means for carrying out the facilitation method.

More particularly, this invention relates to the use of a protective shield for placing over the chip site to prevent contamination of the glass surfaces until permanent repair can be effected, and to methods and means for ensuring the availability of a shield for use when needed.

2. Description of Related Art

Glass surfaces are often chipped or cracked when struck by a pebble or other small, hard object. Vehicle windshields are particularly prone to damage of that sort from flying gravel or other road and vehicle debris. Safety considerations require that the windshield be repaired or replaced if the chip is located at a place where it interferes with the driver's view. Replacement is the least desirable option because of its expense.

There are a number of repair techniques known in the prior art and routinely practiced in the trade. In general, those repair techniques employ a liquid polymeric resin to fill the chip voids and cracks. The resin cures to a transparent solid having an index of refraction sufficiently close to that of glass so as to avoid visual distortions and reflections. Examples of prior art methods and apparatus for repairing chips in glass windshields include those described in U.S. Pat. Nos. 5,614,046 and 6,024,901.

It is necessary that the surfaces of the chip to be repaired be clean and dry in order to obtain a satisfactory repair. If the chip surfaces are dirty or have been contaminated by chemicals, salts or cleaning agents, such as windshield wiper fluid or the cleaning agents used in car washes, the polymer will not properly bond to the glass or will cause visual distortion of the repair area. That problem has been recognized in the art, and techniques have been devised to clean and dry the chip and crack surfaces prior to repair. One such technique and the apparatus for carrying it out are disclosed in U.S. Pat. No. 6,215,955. However, none of the prior art methods provide the performance, convenience and economy as do the means and methods to which this application is directed.

### SUMMARY OF THE INVENTION

This invention, in a first embodiment, comprises a system for providing a protective shield to effect a temporary repair to a chipped or otherwise damaged windshield or other glass member and to keep the chip surfaces clean until a permanent repair can be made. In a second embodiment, this invention includes ways for making a protective shield available to a user at a time of need. The shield itself comprises a transparent plastic sheet having an adhesive coating on one side thereof and is stuck to and carried by a non-adherent backing sheet from which it can be easily removed. The shield is made of a size that that will cover the chip and a perimeter area around the chip so as to maintain the chip surfaces in a clean and dry condition until the shield is removed. A supply of protective shields is provided in a dispenser that is arranged for storage at a location, such as on a key chain or attached to the inner side of the windshield or other protected surface, to allow immediate availability of a shield when a need arises. In a preferred embodiment, the shield, the backing sheet, or both, carry indicia with instructions for use, the identification of a repair service, or other desired information.

### BRIEF DESCRIPTION OF THE DRAWINGS

FIG. 1 is an oblique view of a first embodiment of the protective shield of this invention;

FIG. 2 depicts the shield of FIG. 1 in place on its backing sheet;

FIG. 3 is a plan view of another embodiment of the protective shield having indicia thereon;

FIG. 4 is a plan view of an embodiment of a dispenser for the shields of FIGS. 1 to 3, shown in an unassembled state;

FIG. 5 is an assembled, oblique view of the dispenser of FIG. 4; and

FIG. 6 depicts one form of attachment of the dispenser of FIGS. 3 and 4 to an anchor point.

### DESCRIPTION OF PREFERRED EMBODIMENTS OF THE INVENTION

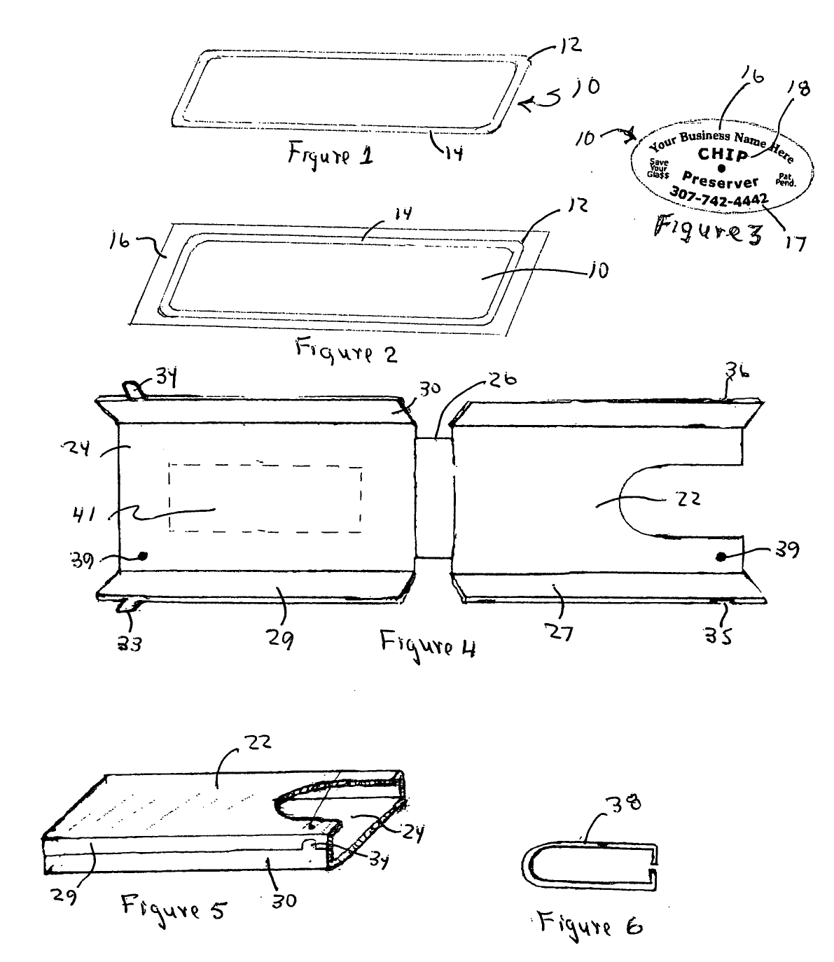

The chip preserver and repair system of this invention will be described with reference to the Figures wherein FIGS. 1 and 2 show a first embodiment of the protective shield at 10. Shield 10 may be constructed of any transparent and durable plastic sheeting material that is resistant to ultraviolet radiation and has sufficient strength to withstand the impact of wind and rain and the abrasion of windshield wipers that might be experienced during ordinary driving. The shield is coated on its under side with an adhesive that will adhere strongly to glass, and is carried on a backing sheet 16 until it is used. Backing sheet 16 may comprise a paper or plastic stock that is treated on at least one side with wax, silicone, or other suitable release agent that forms a weak bond with the adhesive and allows the shield to be easily peeled away.

Shield 10 may be of rectangular shape with rounded corners 12, or alternatively may be shaped as an ellipse, a circle, or ovoid. Those shapes are advantageous as they avoid sharp corners that tend to catch and to be loosened by the action of a windshield wiper blade passing back and forth across the shield. The corners 12 and edges 14 of shield 10 may also be beveled with the thinner edge adjacent the glass surface to allow a windshield wiper blade to more easily ride over the shield. Generally speaking, it is desirable that the shield be as thin as possible consistent with the need for adequate strength to withstand the extremes of weather and windshield wiper abrasion during its use. The shield must be large enough to cover the chipped area and to provide a protective perimeter around the edges of the chip to seal the chip surfaces from water and road contamination. It has been found through experience that the area of damage to a windshield caused by flying gravel or other road debris are often asymmetrical, with a ray or crack extending outwardly in a single direction from the chip crater. The vast majority of reparable chips can be adequately protected by an elliptically shaped shield measuring about 1.5 to 2 inches along its major axis, and about 0.75 to 1.25 inches along its minor axis, and that size and shape are preferred.

FIG. 3 shows a plan view of a preferred embodiment of shield 10. In this embodiment, the shield is of elliptical shape and includes indicia that may, at 16, identify a facility or location that is available to repair the chipped glass and, at 17, provide a contact telephone number for the repair facility. Other miscellaneous information 18 may also be included on the shield. It is desirable that the indicia be legible but not visually intrusive so that the shield does not unduly impair driver visibility.

Incorporation of indicia on the shield in the manner described produces a number of intangible benefits to the user, and to others as well, in addition to the practical benefits obtained by repairing rather than replacing expensive glass. It facilitates widespread use of the chip preserver shield as a give-away, or promotional, premium for an insurance agent, insurance company, or glass repair or replacement group and serves as an effective advertising medium for those entities. For example, insurance agents and insurance companies that deal with property damage coverage have a real and continuing interest in reducing the cost of claims as can be done by the repair rather than replacement of chipped windshields when appropriate to safely do so. At the same time, the insured customers often enjoy a considerable saving, as the cost of repair is typically less than is the glass replacement deductible.

The chip preservation system of this invention can, when used as an advertising premium, provide a very cost effective means for keeping the agent's, or the insurance company's, name and contact information available to the insured. It can be delivered to a customer through routine mailings or can be a focal point for a marketing or promotional project. In similar fashion, the chip protection system may be used as an inexpensive advertising or promotional premium by a glass repair and replacement service and can be offered as a counter sales unit as well. The indicia appearing on the shield is easily customized to fit any marketing or sales program to provide an uncomplicated but highly effective premium.

FIGS. 4 and 5 show one embodiment of a dispenser 20 that is used to store a supply of shields for ready use upon need. Referring particularly to FIG. 4, dispenser 20 may be fabricated as a single piece by injection molding a suitable plastic to form a dispenser body having a front 22 and a back 24 that are connected through bottom 26. A pair of half-width side members 27 ,28 are foldably connected to front 22, and a corresponding pair of half-width side members 29,30 are foldably connected to back 24. A locking tab 33 projects from side 29 and a similar locking tab 34 projects from side 30. Tabs 33 and 34 lockingly fit into receptacle slots 35,36 when the dispenser is folded to its assembled position that is shown in FIG. 5.

As is shown in FIG. 5, the assembled dispenser 20 is open at the top to accept and store a plurality of shields 10 on their respective backing sheets 16. A clip 38 (shown as FIG. 6) may be attached to dispenser 20 by inserting the clip ends into holes 39 that are provided at the top of the dispenser. Clip 38, in turn, may be attached to a key ring or other suitable anchor point. Alternatively, attachment means 41, shown in dashed outline in FIG. 4, may be placed on the back 24 of the dispenser to attach and hold the dispenser at a location convenient to the windshield. Means 41 may conveniently comprise a tape that is arranged to either adhesively or magnetically adhere to an available glass or metal surface.

As may be appreciated from this description, this invention provides a practical and economical method to facilitate the repair of chipped or cracked glass, particularly chipped vehicle windshields. It provides a temporary protection and seal over a chip or crack until repairs can be made. The shield also serves as a promotional means to encourage a more widespread use of repair techniques for vehicle windshields as opposed to their routine replacement when chipped. The invention has been described in relation to certain preferred embodiments that are illustrated in the drawing Figures. It is to be understood that certain variations and modifications of the invention that are not specifically disclosed will, nevertheless, be apparent to those skilled in the art.

1. A method for facilitating the repair of a glass member that has been damaged by chipping or cracking, comprising:
providing a shield comprising a transparent plastic sheet having an adhesive coating on one side thereof that adheres strongly to glass, said shield being adapted to be secured over the site of the damage to keep the damaged glass surfaces clean and dry until a permanent repair can be made;
providing a backing sheet for each said shield, at least one surface of each said backing sheet arranged with a non-adherent surface to which the adhesive coating adheres, but from which said shield may be easily removed;
providing dispenser means for said shields, said dispenser means arranged to hold and store at least one said shield for removal therefrom at time of need; and
securing said dispenser with said stored shield held therein at a location convenient to said glass member.

2. The method of claim 1 including shaping said shield to avoid sharp corners, and sizing said shield such that it covers said damage site and a perimeter area around the site.

3. The method of claim 1 wherein said glass member is a vehicle windshield.

4. The method of claim 3 including providing attachment means integral to said dispenser for securing the dispenser to a selected location.

5. The method of claim 4 wherein the attachment means act through magnetic attraction.

6. The method of claim 4 wherein the attachment means act through adhesive bonding.

7. The method of claim 4 wherein the attachment means act through physical attachment.

8. The method of claim 3 including providing indicia on at least one of said shield, said backing sheet, and said dispenser.

9. The method of claim 8 including employing said indicia to identify a facility that can make repairs to damaged glass.

10. The method of claim 9 including employing said dispensers with shields contained therein as an advertising premium.

11. The method of claim 8 including employing said indicia to identify an insurance agent dealing with property damage.

12. The method of claim 11 including employing said dispensers with shields contained therein as an advertising premium.

13. The method of claim 12 including employing said indicia to identify an insurance company that deals with property damage coverage.

14. The method of claim 13 including employing said dispensers with shields contained therein as an advertising premium.

15. Means for facilitating the repair of damage to a vehicle windshield, comprising:
a transparent shield member having an adhesive coating that strongly adheres to glass on one side thereof, said shield sized to cover the area of damage and a perimeter around the damage area;
indicia placed on said shield member, said indicia legible but not visually intrusive when the shield member is in place over said damage area;
a backing sheet that is adapted to removably attach to the adhesive coating, said backing sheet sized to be at least as large as said shield member;
a dispenser adapted to hold and to store a plurality of said shields, each on its respective backing sheet; and
means to attach said dispenser with its contained shields at a location convenient to said vehicle windshield.

16. The means of claim 15 wherein said dispenser is fabricated from a single piece of plastic to form a body member that is open at the top, and having a front member and a back member that are foldably connected by way of a bottom element, a pair of half-width side members foldably connected to said back and a second pair of half-width side members foldably connected to said front, one pair of said side members having a projecting, locking tab and the other pair of said side members having a tab receptacle slot, said tabs and slots arranged to securely engage when the dispenser body is folded to its assembled position.

17. The means of claim 15 wherein said attachment means comprises a tape disposed on the dispenser back, said tape arranged to adhesively adhere to a surface.

18. The means of claim 15 wherein said attachment means comprises a tape disposed on the dispenser back, said tape arranged to magnetically adhere to a surface.

19. The means of claim 15 wherein said attachment means comprises a clip that is adapted for attachment to an anchor point.

20. The means of claim 15 wherein said shield is shaped as an ellipse having a major axis between about 1.5 and 2 inches in length and a having a minor axis between about 0.75 and 1.25 inches in length.
